(19) United States
(12) Patent Application Publication
(10) Pub. No.: US 2002/0043147 A1
(43) Pub. Date: Apr. 18, 2002

(54) Pitch relative, compensating vibrato device

(76) Inventor: James Herbold, Kirkland, WA (US)

Correspondence Address: DEAN A. CRAINE, P.S., Suite 140, 400 112th Avenue NE, Bellevue, WA, 98004-5542, US

(21) Appl. No.: 09/948,509

(22) Filed: Sep. 6, 2001

Related U.S. Application Data
(60) Provisional application No. 60/230,843, filed on Sep. 7, 2000.

(51) Int. Cl. G10D 3/00

(52) U.S. Cl. 84/313

(57) ABSTRACT

A vibrato device for a guitar which allows a guitarist to maintain the relative pitch on each string when using the vibrato arm. The vibrato device consists of a string deflection assembly, a fixed deflection mounted to the top surface of a guitar, and a pivoting tension assembly located inside the guitar. The deflection assembly includes a deflection plate which includes a plurality of longitudinally aligned grooves and six horizontal holes for the saddles to sit over. Adjustable saddles with longitudinally aligned teeth formed on their bottom surface are placed over the deflection plate and engage the grooves. During use, the strings pass over the saddles and force the teeth to engage the grooves to securely hold the saddles in place over the deflection plate thereby eliminating the need for screws. The tension assembly includes a string attachment member and a support bracket. The string attachment member includes a cylindrical component with a rearward-directed horizontal plate and a downward directed vertical plate attached. The vibrato arm is directly attached to the cylindrical component and rotates with the vibrato arm is used. The ends of the strings are attached to one hole located in a row of holes which are longitudinally aligned on the horizontal plate. By selecting different holes in a row, the guitarist is able to adjust the length between the distal end of the string and the pivot point on the deflection plate. When the vibrato arm is rotated, the ends of the string move in different arcs of rotation to maintain current relative pitch.

This is a utility patent application based on a provisional patent application (Ser. No. 60/230,843) filed on Sep. 7, 2000.

### BACKGROUND OF THE INVENTION

1. Field of the Invention

This invention relates to a vibrato device for a guitar, and more particularly, to a vibrato device which maintains the relative pitches between the guitar strings when the vibrato arm is used.

2. Description of the Related Art

Guitars equipped with a vibrato device that enable a guitarist to create a vibrato effect on the strings when playing the guitar have been used since the 1950's (See U.S. Pat. No. 2,741,146). Conventional vibrato devices use a vibrato arm connected to a base that pivots around its front edge when the vibrato arm is used. Each guitar string is connected to the distal end of the base plate and extends over an adjustable bridge positioned over the front edge of the base plate. Attached to the base plate is a vertically aligned bar that extends into the guitar body. A plurality of springs is attached to the lower end of the bar which resiliently holds the bar in a vertical orientation inside the guitar body and applies a forward directed tension force thereto to offset the tension applied by the strings. The guitar strings extend over the bridge and down through the bar. The vibrato arm is attached to the base plate which, when lowered or raised, causes the base plate to pivot and thereby adjust the length and tension of each string to produce the vibrato effect.

One drawback with conventional vibrato devices is that the ends of the strings are attached at a fixed location on the base plate so that the length of the strings are lengthened or shortened the same amount when the vibrato arm is used. Because each string is under different tension, the relative pitch of each string changes, making the guitar sound out of tune when the vibrato arm is used.

Another drawback with conventional vibrato devices is that the bridge is made of six independently adjustable bridge elements that are individually attached to the base plate via small screws. During use, the string vibrations must travel through the bridge elements and screws to the guitar body which reduces the overall sound quality of the instrument.

To overcome the above-mentioned drawbacks, a simple vibrato device is needed that allows for relative pitches of the strings to be maintained when the vibrato arm is used. Such a vibrato device should also eliminate the use of screws that reduce the quality of sound.

### SUMMARY OF THE INVENTION

It is an object of the present invention to provide a simple vibrato device for a guitar.

It is another object of the present invention to provide a vibrato device that allows for relative pitches of the strings to be maintained when the vibrato arm is used.

It is a further object of the present invention to provide such a vibrato device that uses interconnected components that provide improved sound qualities.

These and other objects are met by a simple vibrato device for a guitar that allows the strings to maintain their relative pitches when the vibrato arm is used. The vibrato device includes a string deflection assembly mounted on the top surface of the guitar body and a pivoting tension assembly located inside the guitar body. The string deflection assembly includes a deflection plate that has a plurality of longitudinally aligned, parallel grooves formed over its top surface and six parallel, transversely aligned string slots through which the strings may extend. The string deflection assembly also includes six saddles longitudinally aligned and placed side-by-side over the top surface of the deflection plate. Formed on the bottom surface of each saddle are transversely aligned teeth that engage complimentary-shaped grooves formed on the top surface of the deflection plate. During use, teeth on the saddles mesh with the grooves in the deflection plate to securely hold the saddles in position over the deflection plate. The teeth and grooves also increase the amount of contact surface area between each saddle and the deflection plate, thus increasing the amount of string vibration transmitted to the guitar body.

Each saddle includes a string passageway and a transversely aligned roller pin. During use, a string is extended over the roller pin and then connected to the pivoting tension assembly located inside the guitar body and below the string deflection assembly. When the strings are tightened, a downward force is applied to the saddles to hold them in a fixed position over the deflection plate. Each roller pin is disposed transversely in each saddle between the cylindrical bores formed on the opposite sides of each saddle. The relative clearances between the roller pin and each bore are sufficiently loose to insure that the roller pin's area of contact is confined to the lower or bottom section of the bore. During use, the roller pin is able to rotate inside the bore and its longitudinal axis is able to move fore or aft relative to the guitar body as the roller pin rotates inside the saddle. Because the roller pins are able to freely rotate inside the bores and be in constant contact with the saddle, string vibration is more effectively transmitted to the guitar body.

The pivoting tension assembly is located inside a cavity formed inside the guitar body under the deflection plate and includes a pivoting string attachment member, a plurality of tension springs and a spring support bracket. The string attachment plate includes a cylindrical component with an integrally attached rearward extended horizontal plate and an integrally attached downward extended vertical plate. The vibrato arm is attached to the downward oriented vertical plate so that the cylindrical component rotates when the vibrato arm is used by the guitarist. The ends of the strings extend downward from the deflection plate and are attached to the horizontal plate. When the cylindrical component is rotated in a counter-clockwise direction by the vibrato arm, the horizontal plate rotates and reduces the tension on the strings.

Formed on the horizontal plate are six rows of holes equally spaced apart and longitudinally aligned and spaced apart and assigned. During use, each row is assigned to a string and the end of the string is selectively inserted through one of the holes in its assigned row. By selecting and attaching the end of the string to a different hole in the row, the user may adjust the length of the section of string, located between the distal end of the string and the saddle, to the saddle. This allows for the relative string tension to be compensated by moving the end of each string a different distance through an arc of rotation to maintain correct relative to pitch. This feature follows Archimedes' theory on levers.

The vertical plate is aligned ninety degrees from the horizontal plate and attached to three springs attached at one end to the support plate securely attached to the guitar body. The springs apply tension to the string attachment member to offset the tension applied by the strings to the horizontal plate.

### BRIEF DESCRIPTION OF THE DRAWINGS

FIG. 1 is a perspective view of the pitch relative compensating guitar vibrato device.

FIG. 2 is a side elevation view of the vibrato device.

FIG. 3 is a front elevation view of the vibrato device.

FIG. 4 is a front elevation view of the vibrato device.

FIG. 5 is a rear elevation view of the vibrato device.

### DESCRIPTION OF THE PREFERRED EMBODIMENT(S)

As show in the accompanying Figs, a vibrato device 10 for a guitar body 90 which allows a guitarist to change the pitch of all the strings 92-97 the same amount when using the vibrato arm 42.

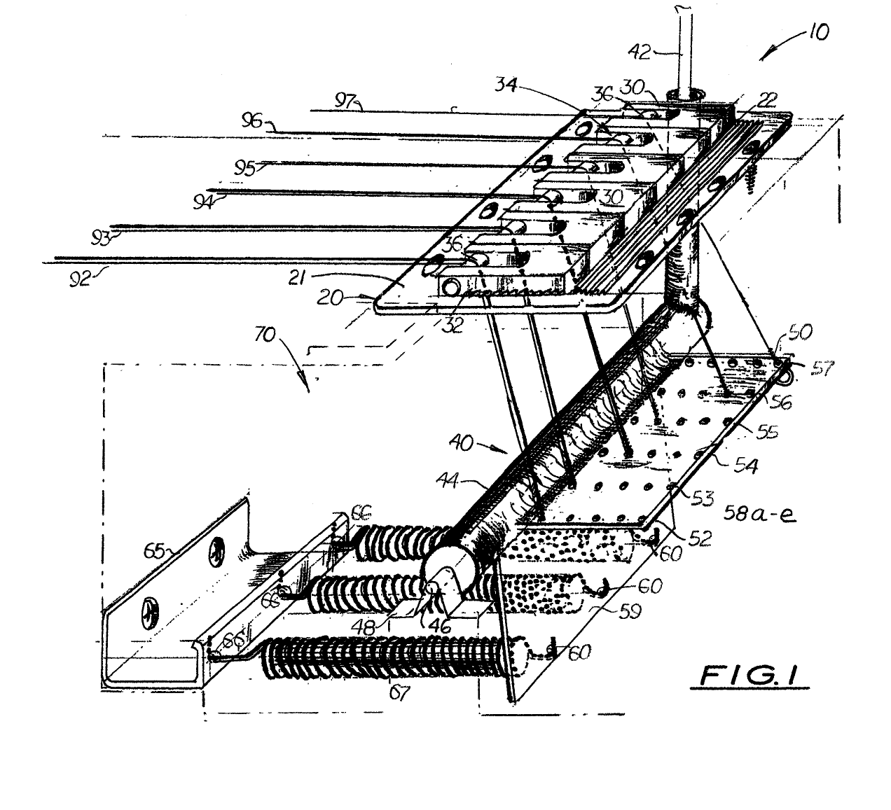

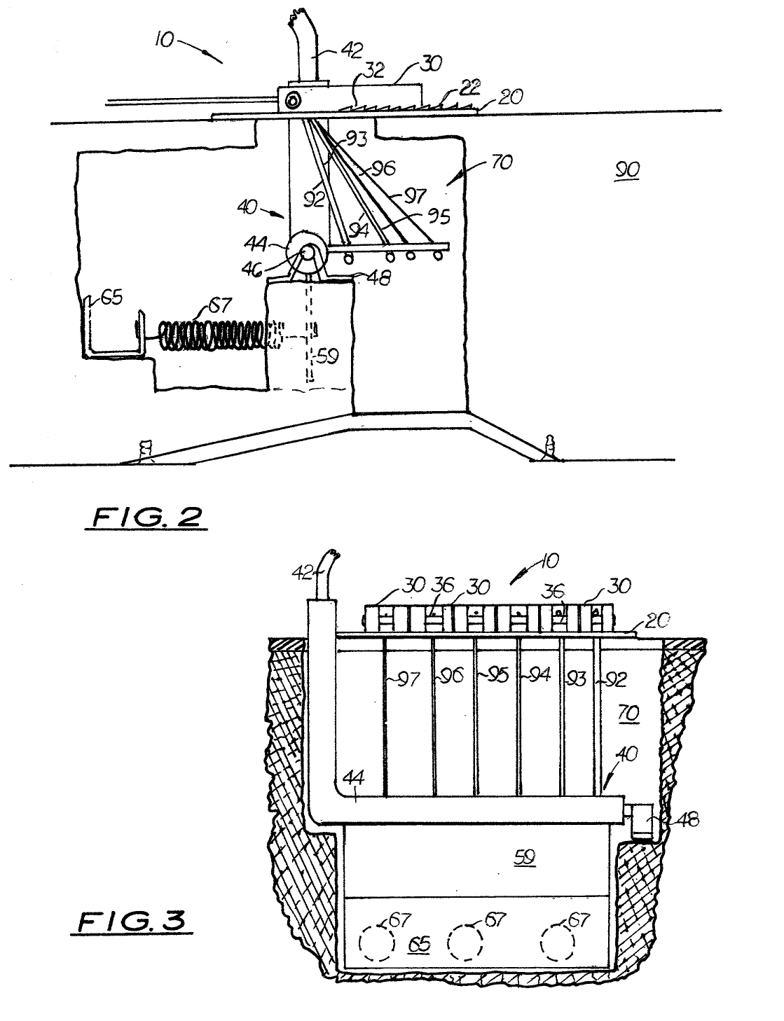

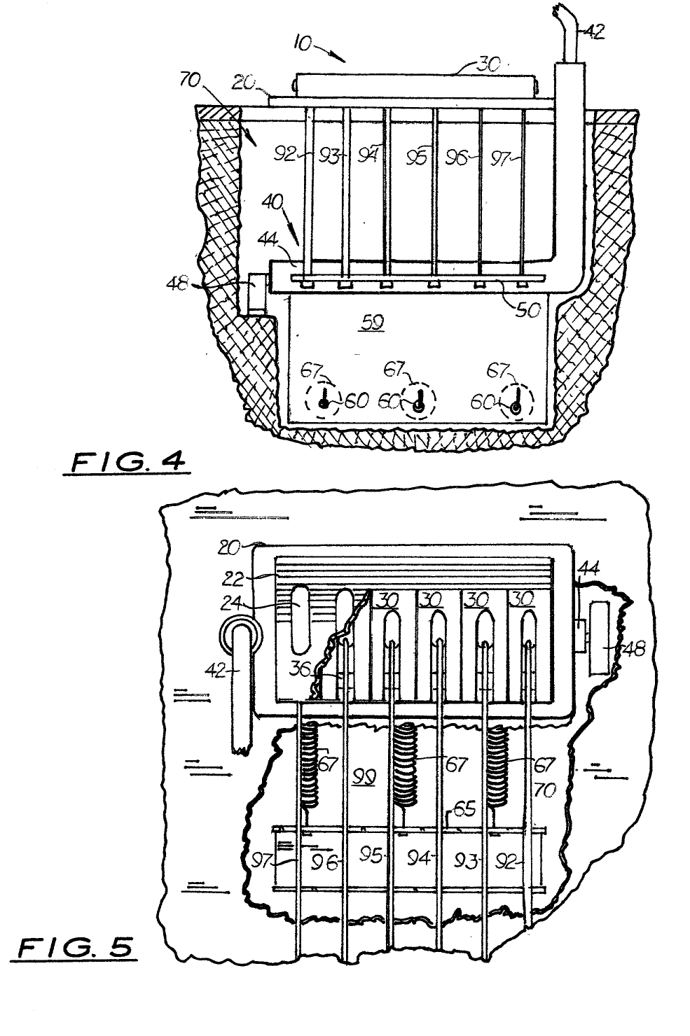

As shown in FIG. 1, the vibrato device 10 consists of a fixed, deflection plate 20, a pivoting tension assembly 40, and a spring bracket 65. The deflection plate 20, transversely securely attached to the top surface of the guitar body 90, includes a plurality of longitudinally aligned grooves 22 formed on its top surface 21. Formed inside the deflection plate 20 are six string openings 24 that enable the guitar strings 92-97 to extend through and connect to the pivoting tension assembly 40 located inside the guitar body 90.

Aligned transversely over the top surface 21 of the deflection plate 20 are six parallel saddles 30. Each saddle 30 is flat and U-shaped and includes a central passageway 34. Disposed transversely inside the central passageway 34 is a smooth, round pin 36. Formed on the bottom surface of each saddle 30 is a plurality of transversely aligned teeth 32 designed to engage the grooves 22 formed on the deflection plate 20. During use, one guitar string is placed over the pin 36 and extended downward through the central passageway 34 and into the guitar body 90. The saddles 30 may be moved longitudinally over the deflection plate 20 thereby adjusting the position of the pin 36. During use, teeth 32 mesh with the grooves 22 in the deflection plate 20 and the strings 92-97 pass over the saddles 30 at a substantially large angle to create downward force to securely hold the saddles 30 in place over the defection plate 20.

The pivoting tension assembly 40 is located inside a cavity 70 formed in the guitar body 90 directly under the deflection plate 20. The pivoting tension assembly 40 includes a vibrato arm 42 integrally attached to a cylinder component 44. Extending longitudinally from each end of the cylinder component 44 is a pin 46 which connects to a bracket 48 attached to a support surface in the guitar body 90 to hold the cylinder component 44 inside the cavity 70. Formed on the cylinder component 44 are a rearward extending horizontal plate 50 and a vertical plate 59. The horizontal plate 50 has six transversely aligned rows 52-57 of holes 58a-e. In the preferred embodiment, there are five holes 58a-e equally spaced apart and formed in each row 52-57. Each hole 58a-e allows the end of one of the six individual strings 92-97 to pass through and connect to the horizontal plate 50. By selecting different holes 58a-e in each row 52-57, the length of the section of string located between the horizontal plate 50 and the saddle 30 can be varied. The vertical plate 59 is aligned ninety degrees from the horizontal plate 50 and includes at least three holes 60 designed to receive the distal ends of three springs 67.

Located inside the cavity 70 and across from the cylinder component 44 is a spring support bracket 65 rigidly connected to the inside surface of the guitar body 90. The spring support bracket 65 includes three holes 66 designed to receive the proximal end of three springs 67 disposed between the bracket 65 and the vertical plate 59. Screws 71,72 are used to attach the spring support bracket 65 to the inside surface of the cavity 70. During use, the springs 67 apply a rotation force to the vertical plate 59 so that the horizontal plate 50 is extended downward.

During use, the guitarist forces the vibrato arm 42 inward and causes the cylinder component 44 to rotate counter-clockwise. When the cylinder component 44 rotates in a counter-clockwise direction, the horizontal plate 50 rotates upward thereby shortening the length of the strings 92-97. The amount of tension reduced on the strings 92-97 varies depending on the hole 58a-e selected on the row 52-57 of holes 58a-e located on the horizontal plate 50. The closer the strings 92-97 are to the cylindrical component 44, the less they move when the vibrato arm 42 is used. The holes 58a-e enable the strings 92-97 to all change the same pitch.

In compliance with the statute, the invention, described herein, has been described in language more or less specific as to structural features. It should be understood, however, the invention is not limited to the specific features shown, since the means and construction shown comprise only the preferred embodiments for putting the invention into effect. The invention is, therefore, claimed in any of its forms or modifications within the legitimate and valid scope of the amended claims, appropriately interpreted in accordance with the doctrine of equivalents.

I claim:

1. A pitch relative compensating vibrato device, comprising:
a. a deflection plate attached to a guitar body, said deflection plate including a plurality of adjustable saddles;
b. a pivoting tension assembly located inside said guitar and below said deflection plate, said pivoting tension assembly including a vibrato arm attached to a cylindrical component, said cylindrical component including a horizontal plate and a vertical plate, said horizontal plate having a plurality of rows of holes transversely aligned therein capable of receiving and holding the end of a string, and;
c. a vibrato biasing means connected to said vertical plate to keep said horizontal plate horizontally aligned.

2. A vibrato device as recited in claim 1, wherein said deflection plate includes a plurality of parallel and longitudinally aligned grooves that are selectively engaged by said saddles to lock said saddles in a fixed position on said deflection plate.

3. A vibrato device as recited in claim 2, further including each said saddle having a set of teeth formed thereon that engage said grooves on said deflection plate.

4. A vibrato device as recited in claim 1, further including each said saddle including a U-shaped opening with a transversely aligned rotating pin located therein.

5. A vibrato device, as recited in claim 4, wherein said pin is disposed inside holes formed on the opposite sides of the U-shaped opening on said saddle, said holes having a larger diameter than said pins so that vibrations are transmitted through a small contact area to said saddle.

6. A vibrato device, as recited in claim 1, wherein said vibrato biasing means is a support plate bracket mounted inside the guitar body and a plurality of springs disposed between said bracket and said vertical plate.

7. A vibrato device, as recited in claim 1, wherein said holes in each said row of holes are approximately ⅛ inch apart.

8. A vibrato device, as recited in claim 1, wherein said holes in each said row of holes are sufficiently spaced apart so that different strings attached thereto may be maintained in relative pitch when said vibrato arm is used.

9. A pitch relative compensating vibrato device, comprising:
a. a deflection plate attached to a guitar body, said deflection plate including a plurality of adjustable saddles;
b. a pivoting tension assembly located inside said guitar and below said deflection plate, said pivoting tension assembly including a vibrato arm attached to a cylindrical component, said cylindrical component including a horizontal plate and a vertical plate, said horizontal plate having a plurality of rows of holes transversely aligned therein capable of receiving and holding the end of a string, said holes in each said row of holes are sufficiently spaced apart so that different strings attached thereto may be maintained in relative pitch when said vibrato arm is used, and;
c. a vibrato biasing means connected to said vertical plate to keep said horizontal plate horizontally aligned.

10. A vibrato device as recited in claim 9, wherein said deflection plate includes a plurality of parallel and longitudinally aligned grooves that are selectively engaged by said saddles to lock said saddles in a fixed position on said deflection plate.

11. A vibrato device as recited in claim 10, further including each said saddle having a set of teeth formed thereon that engage said grooves on said deflection plate.

12. A vibrato device as recited in claim 9, further including each said saddle including a U-shaped opening with a transversely aligned rotating pin located therein.

13. A vibrato device, as recited in claim 12, wherein said pin is disposed inside holes formed on the opposite sides of the U-shaped opening on said saddle, said holes having a larger diameter than said pins so that vibrations are transmitted through a small contact area to said saddle.

14. A vibrato device, as recited in claim 9, wherein said vibrato biasing means is a support plate bracket mounted inside the guitar body and a plurality of springs disposed between said bracket and said vertical plate.
